(19) United States
(12) Patent Application Publication
(10) Pub. No.: US 2009/0060149 A1
(43) Pub. Date: Mar. 5, 2009

(54) AUTOMATED TELEPHONE NOTIFICATION SYSTEM USING VOICE OVER INTERNET PROTOCOL (VoIP)

(76) Inventors: Matthew J. PAVELKO, Lebanon, PA (US); Neil A. Weaver, Hummelstown, PA (US)

Correspondence Address: MCNEES WALLACE & NURICK LLC, 100 PINE STREET, P.O. BOX 1166, HARRISBURG, PA, 17108-1166, US

(21) Appl. No.: 11/846,309

(22) Filed: Aug. 28, 2007

(51) Int. Cl. H04M 11/00

(52) U.S. Cl. 379/88.17; 379/88.18

(57) ABSTRACT

A system or method for automatic telephone notification using Voice over Internet Protocol (VoIP) includes a data portal having a web interface or portal software to connect to a master server. The data portal accesses a client's database and generates a customer list that includes customer records. A master server receives recorded messages from a remote location through an Interactive Voice Response (IVR). The master server also communicates instructions for placing alert message telephone calls to customers on the list. A call server array has multiple servers in communication with the master server and a VoIP network. The call server array receives instructions from the master server, and places alert message telephone calls according to the instructions communicated from the master server. The server array broadcasts calls over a VoIP network to customers.

### BACKGROUND

The application generally relates to an automated telephone notification system, and more particularly to an automated telephone notification system using Voice over Internet Protocol (VoIP) to broadcast voice messages such as public utility emergency notices to customers identified in a client database.

In the event of a public emergency, organizations such as municipal, state and federal government agencies, public utilities and on occasion, private organizations, have a need or desire to notify members of the public, either to inform them of an impending or existing crisis that may affect them. Such notifications provide a service that informs the public so that they may be better prepared to react to or prepare for the emergency. In the event of a public utility, for example, interruptions of service may be of interest to a subset of the total set utility customers.

Generally, such entities maintain existing databases of their customers or constituents for various purposes, for example accounting, service or contacts for emergency notification. While the data may include the necessary customer information for notification, the process of identifying the relevant customers that are affected by an emergency, preparing the appropriate content for the message, and delivering the notification in a timely manner, presents complex and sometimes massive data sorting functions and logistical challenges. The target customers may be a large subset of the total customer base, even the entire customer base, or it may involve a select few customers that are identifiable only through specified data sorting algorithms. Generally the notification criteria relate to geographic data that may be cross-referenced to telephone numbers to generate the specific listing of target customers to be notified. Once identified, the utility or government agency must arrange to contact every identified customer if possible. While mass media outlets such as television, radio and the Internet are resources that are often used for such notifications, not all of the affected or target customers may have access to, or be listening to, the particular channel, station or website, at the time that an announcement is made. Specific telephone notification requires placing many calls simultaneously, a technical challenge in itself.

What is needed is a system and/or method that satisfies one or more of these needs or provides other advantageous features. Other features and advantages will be made apparent from the present specification. The teachings disclosed extend to those embodiments that fall within the scope of the claims, regardless of whether they accomplish one or more of the aforementioned needs.

### SUMMARY

One embodiment relates to a system for automatic telephone notification using Voice over Internet Protocol (VoIP). The system includes a data portal module associated with a database having an interface module for connecting the system to the Internet. The data portal module is configured to access the database to query the database for customer related information and to identify a data subset of the database. The data portal module is also configured to generate a customer list that includes customer records; create and save voice notification messages from textual sources; record notification messages for distribution via telephone; and provide an interface between the system and a website. The system includes a master server computer configured to receive recorded messages from a remote location; receive a post-call data report related to a predefined alert call message; and communicate instructions for placing alert message telephone calls to the at least one customer list. A call server array has one or more call servers in data communication with the master server computer and with a VoIP network. The call server array receives the instructions for placing alert message telephone calls from the master server, and places alert message telephone calls according to the instructions communicated from the master server. The call server array also receives alert call data from the VoIP network and transmits the received alert call data to the master server. The alert call message is broadcast over a VoIP network to the customers identified in the call list.

Another embodiment relates to a method of automatically placing emergency notification calls over a VoIP telephone network. The method includes the steps of initiating a web session at a remote customer location; providing a plurality of options, including an edit call option, a place call option, and a report option; and selecting one option from the plurality of selection options.

In response to selecting the edit call option, the method includes performing one of: uploading at least one message file from a local resource; downloading message files from a master server to the local resource; and deleting message files from the master server; uploading at least one formatted telephone list file to the master server from the local resource; downloading formatted telephone list files from the master server to the local resource; and deleting formatted telephone list files from the master server.

In response to selecting the place call option, the method includes performing one of: configuring a plurality of parameters for mass call distribution of a preselected message file selected from the at least one message file; initiating a call; and testing at least one telephone number using the preselected message file, up to a predetermined maximum number of telephone numbers.

In response to selecting the reports option, the method includes performing one of: viewing a data set including results of calls being placed in real time; cancelling a telephone message call that is currently being placed; reviewing a schedule for placing recorded messages; cancelling one or more of the scheduled recorded messages; downloading telephone message call summary reports; downloading failed number reports; and downloading detail historical data records of calls.

Certain advantages of the embodiments described herein include variable sizes of call list, a plurality of dial attempts for each notification event, multiple telephone numbers, e.g., up to four—per customer account, automatic redial capability; answering machine detection; use of multiple call servers; and increased bandwidth.

An advantage of the invention is a data portal capable of automatically generating customer calling lists derived from a client proprietary database.

Another advantage of the invention is the ability to generate repeat calls multiple times for each number.

Another advantage of the invention is the ability to associate multiple telephone numbers for each account to be contacted or notified.

A further advantage is a message center having interactive voice response (IVR) menus and text to speech capability.

Yet another advantage is the ability to generate customer statistical and historical reports from the web server and to upload detailed call data into the customer database; and the ability to program caller-ID functions.

Alternative exemplary embodiments relate to other features and combinations of features as may be generally recited in the claims.

### BRIEF DESCRIPTION OF THE FIGURES

The application will become more fully understood from the following detailed description, taken in conjunction with the accompanying figures, wherein like reference numerals refer to like elements, in which:

FIG. 1 is a diagram of an exemplary telephone notification system.

FIG. 2 is a schematic diagram of the system website.

FIG. 3 is an exemplary screen display of the Edit or Manage Call option.

FIG. 4 is an exemplary screen display of the Place A Call option.

FIG. 5 is an exemplary screen display of the Reports option.

FIG. 6 is an alternate embodiment showing a facility for querying the customer's database and generating phone lists.

FIG. 7 is an alternate embodiment showing a facility for recording a local message via microphone to be uploaded to the system via the website.

FIG. 8 is an alternate embodiment showing a facility for generating a local, synthesized message using TTS to be uploaded to the system via the website.

FIG. 9 is an alternate embodiment showing the web interface displayed inside the portal software.

Wherever possible, the same reference numbers will be used throughout the drawings to refer to the same or like elements.

### DETAILED DESCRIPTION OF THE EXEMPLARY EMBODIMENTS

Before turning to the figures which illustrate the exemplary embodiments in detail, it should be understood that the application is not limited to the details or methodology set forth in the following description or illustrated in the figures. It should also be understood that the phraseology and terminology employed herein is for the purpose of description only and should not be regarded as limiting.

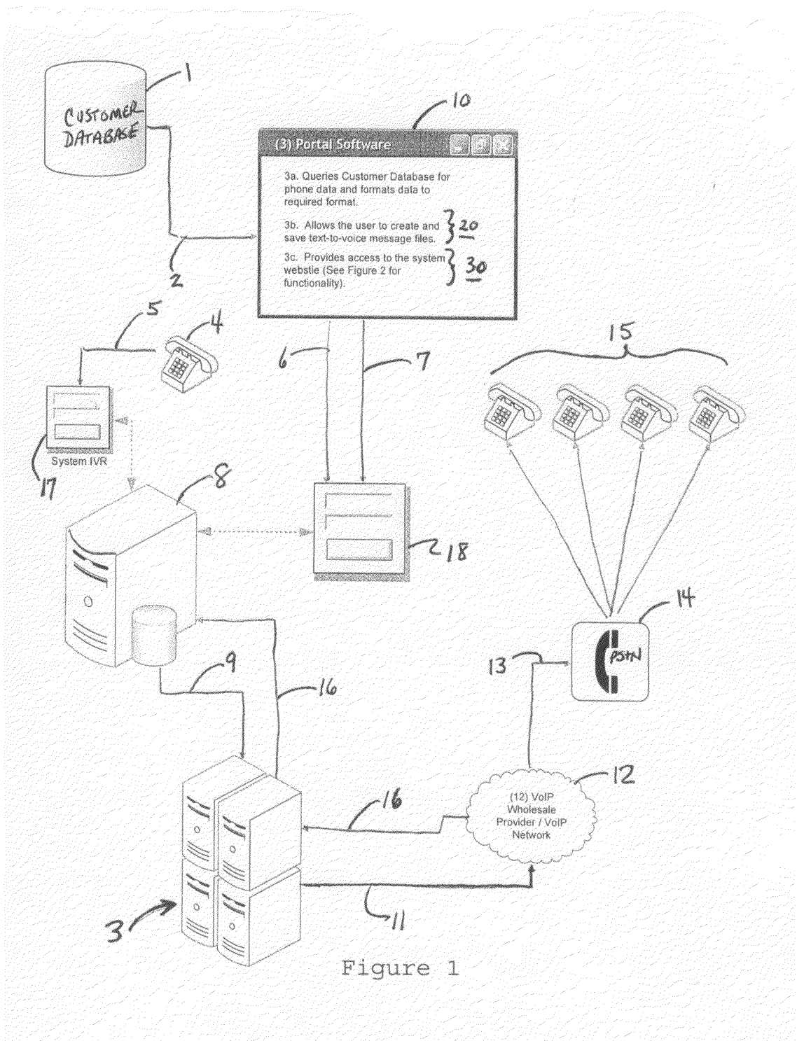

Referring to FIG. 1, the novel system for telephone notification using Voice over Internet Protocol (VoIP), includes four main components: a data portal 10; an Interactive Voice Response (IVR) module 17; a web or Internet interface 18, both of which reside on a master server 8; and a call server array 3.

A customer database 1 includes customer data associated with a client's customers. The system 100 can receive information from any database or GIS (Geographic Information System) in which all the customer data is stored. The system 100 is operable with any type of database, depending on the application and particular customer data 1. By way of example and not limitation, customer databases' may be two-dimensional or flat, hierarchical, or relational databases. In most instances the customer database is a client owned and controlled database that exists prior to system 100 implementation. An example of a customer database is a customer billing database. The data in the database is provided to the data portal 10 via a data communications link 2. The data communications link 2 may be interconnected with the data portal 10 through The Internet or other wide area network (WAN), or through other known data channels such as local area or wireless networks, telephone, T1 lines, and similar data channel interconnections.

The data portal 10 may be customized for client proprietary databases, and can include many or few functions, depending on the application. The data portal accesses the customer database 1 to query the customer database 1, or to ‘drill down’ in order to identify a data subset of the customer database 1 that is responsive to the query. Upon completion of a query, the data portal 10 generates a formatted list of records each with a unique customer identifier, and up to four telephone numbers to contact the customer associated with the unique customer identifier. In one embodiment all fields are comma separated. The user may select to save the formatted list in a local data file stored on the user's local computer or a local network with which the user's computer is in data communication.

The system 100 in one embodiment includes text-to-voice message functionality to generate a voice message file from a textual source, e.g., a computer-generated voice message is created from a text file stored on a local computer (not shown) that is executing or operating the data portal, or by recording the voice message directly through a microphone connected to the computer. The user may select the option to save the voice message in a local voice file stored on the user's local computer or a local network with which the user's computer is in data communication. Alternately, the system 100 may automatically direct the voice message to a default location on the local computer or local network. When using the IVR 17, the sound files are automatically saved to the master server 8. When using any method of the portal to create message however, the file is created and stored locally, similar to the phone list storage configuration described previously.

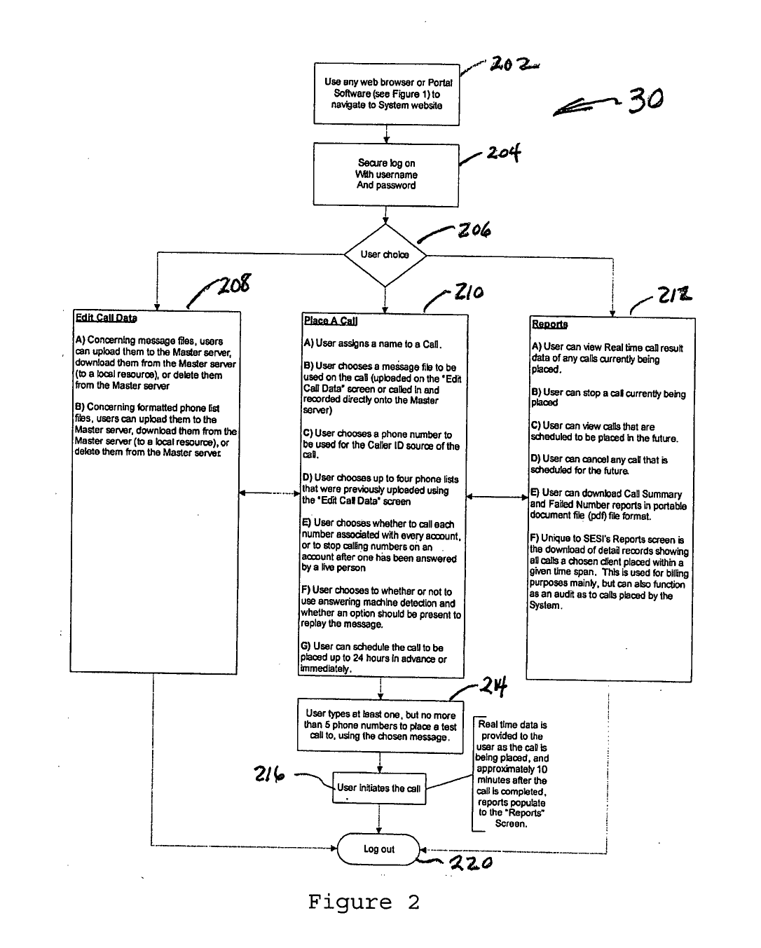

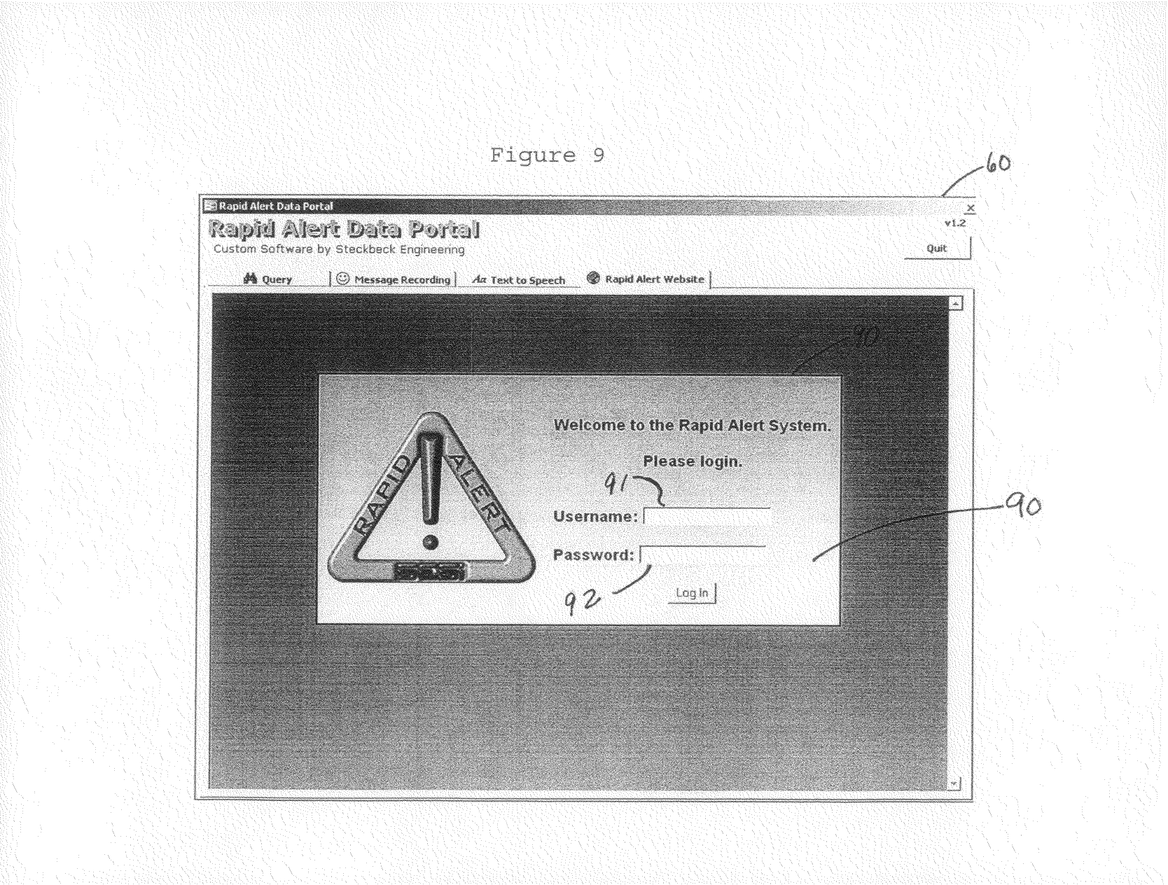

The data portal 10 also provides access to a system website (See, e.g., FIG. 9) via a web browser ‘object’ embedded into the data portal 10. The website is described in greater detail below, with respect to FIG. 2. The data portal 10 is configured on user's local PC (not shown). Data portal 10 communicates with the master server 8 via Internet, in particular the website or web interface 18 that is hosted by the master server 8. Voice link 6 and data link 7 are connected through the website, preferably via the data portal 10, to upload phone lists and message files.

The master server 8 is a computer system that has been designated for executing or operating the telephone notification system 100 and related applications. The master server 8 is preferably dedicated to the functions of the telephone notification system 100, although other applications may be operated from the master server 8. Customers may use any telephone 4 that is connected to the Public Switched Telephone Network (PSTN) to communicate with the master server 8. For example, the customer telephone 4 may be used to call the IVR 17, which is being served by the master server 8 to record messages.

The master server 8 generates IVR message prompts that assist the customer to record notification messages for distribution via telephone. The recorded notification messages are then saved to a folder where they can be retrieved later and played when automated calls are being placed to customers. In one embodiment, up to ten messages can be recorded and stored in a directory on the master server 8 at one time, although more messages may be stored depending on the application. The user may assign a unique numerical identifier to each stored message that it records, e.g., from zero through nine in the exemplary embodiment. The stored messages can be retrieved later by reference to the unique identifier assigned to it. Any audio file, e.g., a file in the standard .wav format, may be uploaded via the text to voice message uplink 6 to the master server 8 via the website 30. The website is also housed on the master server 8. The audio file is typically, but not exclusively, created by the data portal 10 in text to voice message module 3b. Also, comma-separated files may be uploaded to the master server 8 via data link 7 containing formatted telephone data. Each telephone data file includes 5 fields, the first being a unique identifier among the record set, the remaining four fields contain 10-digit, telephone numbers, which telephone numbers are preferably unformatted. The telephone data file is also typically, but not exclusively, created using the data portal data portal 10, software module indicated as 3a.

The master server 8 executes multiple tasks, including serving the system website 30, storing all customer lists, e.g., phone lists and messages, providing administrative and telephone call instructions for servers in a call server array 3 to place telephone calls to the listed customers and to manage the telephone calls; accumulating and storing call detail records for back office functions such as reporting and billing. While customer data is stored in the customer database 1, certain phone lists can be created and reused by the user if so desired. The master server 8 data list storage capacity also provides redundancy for the user if, for example, the user customer database 1 is out of service or otherwise inaccessible, and it is not possible to query the customer database 1 to obtain telephone numbers. If a user uploads a master list to the system, the user can refer to the uploaded master list.

An instruction message 9 is transmitted from the master server 8 to the call server array 3 when a call is placed. The message 9 includes instructions from the master server 8 to the call server array 3, including instructions for placing telephone calls. The call server array 3 includes a bank of interconnected computers and associated software, which are dedicated primarily for the purposes of placing the telephone calls through a VoIP provider network 12, and reporting back to the master server 8. In an alternate embodiment, the master server 8 can also serve as a call server in the call server array 3, in addition to performing the functions of the master server 8. In some cases, such as where there is a low number of calls to be placed, the call server array 3 can be completely implemented in the master server 8, with the master server 8 functioning as the sole server of the call server array 3.

Telephone calls 11 are passed to the VoIP network 12 via an Internet link 11 or a local area network (LAN) IP-based network. The VoIP network may be provided by any provider, and the network can change. The system 100 is may be configured to place VoIP calls through one or more VoIP wholesalers, depending on various factors, e.g., cost and call volumes. The VoIP network 12 distributes the telephone calls via communications link 13 to a Public Branch Exchanges (PBE) (not shown) in the Public Switched Telephone Network (PSTN) 14. The PSTN 14 connects the telephone calls to end-user telephone equipment 15. The end-user telephone equipment 15 may include conventional landline telephones, cell phones, answering machines, and voicemail that can receive telephone calls. Following a call session, post call detail information 16 is returned over a communication link 11 to the master server 8. The post call detail information 16 includes call disposition (how the system detected the call as being answered, for example, by an answering machine or by an actual person) and length of each call. The system may be customized to include additional statistical information on each call, for client analysis.

Referring next to FIG. 2, there is a schematic diagram of the system website generally designated as 30. At step 202, a user initiates a web session using any web browser, or using the data portal 10 (See, e.g., FIG. 1). The web browser or data portal 10 enables the user to navigate to the website 30. Once connected to the website 30, a secure logon 204 screen is displayed, and the user is required to enter an authorized username and password to gain entry into the user choice screen 206. The user choice screen 206 provides three main selection options, edit call 208, place a call 210, and reports 212.

The edit call option 208 provides facilities for users to upload message files from a local resource 4, e.g., a computer or telephone, (See e.g., FIG. 1) onto the master server 8, download message files from the master server 8 to the local resource 4, or to delete message files. The edit call option 208 also provides users the option to upload formatted telephone list files to the master server 8 from the local resource 4, to download formatted telephone list files from the master server 8 to the local resource 4, or to delete formatted telephone list files from the master server 8.

The place call option 210 permits the user to configure the parameters for mass distribution of a voice message. At step 210a, the user assigns a unique identifier name to the call for identification and automatic retrieval of the call parameters from a hard drive location. Next, the system proceeds to step 210b, in which the user selects a message file to be broadcast to a particular call list, which list is to be defined in a later step. The message file may be a file that has been uploaded to the master server 8 in the edit call option 208, or that has been recorded directly to the master server 8 from a client telephone 4. The system proceeds to step 210c, where the user assigns a telephone number that is an authorized caller identification (ID) source of the broadcast request or call. The authorized caller ID indicates to call recipients the name of the originator, and provides the recipients a number to return the call. The system then proceeds to step 210d, in which the user selects a predetermined number of telephone lists, e.g., four lists. The telephone lists are available from the master server 8, having been uploaded to the master server 8 in the call edit selection 208. The system then proceeds to step 210e, and the user is provided an option to select whether to call each of the telephone numbers that are associated with every customer account, or whether to call the telephone numbers that are associated with the customer account in a predetermined order until a live person answers a call, and discontinue calling at that point. The system then proceeds to step 210f, and the user optionally selects to use answering machine detection means, and to provide an option for the end-user to replay the message. The system then proceeds to step 210g, in which the user selects the timing of broadcasting the call, ranging from an immediate broadcast up to a predetermined maximum advance time, e.g., 24 hours in advance. The calls are broadcast by the system 100 at the preassigned time.

Following the place call option 210 steps a through g, the website 30 proceeds to a test option at step 214, where the user is directed to type at least one telephone number, up to a predetermined maximum, e.g., five telephone numbers, to which test calls are to be place using the preselected message.

After the user enters the test telephone numbers, at step 216 the user initiates the test calls, and receives real time data to the user as the calls are being placed. Within approximately 10 minutes after completion of the calls, call data populates the Reports screen 212, below. The time between completion of the calls and the populating of the reports screen may be approximately 10 minutes on average, which depends upon the algorithm used to generate the call data. For example., the Big-Oh notation may be used, in which the time to generate the data is directly proportional to the square of the size of the number of calls placed. Finally, the user is given the option to log out at step 220.

Another user option at step 206 is a reports option 212. In the reports option 212, the user can view the data showing the results of any call currently being placed in real time at step 210a. In step 210b, the user is provided with the capability to cancel a telephone message call that is currently being placed. In step 210c, the user has the option to review recorded message calls that are scheduled to be placed. In step 210d, the user may cancel any recorded message calls scheduled to be placed. In step 210e, the user can download telephone message call summary reports and failed number reports, e.g., in a portable document format (PDF), or hypertext markup language (HTML) format. Finally, at step 210f, the user may download detail historical data records of all calls that a client has placed over any selected time span, e.g., to prepare billing statements, or to audit recorded message calls placed by the system.

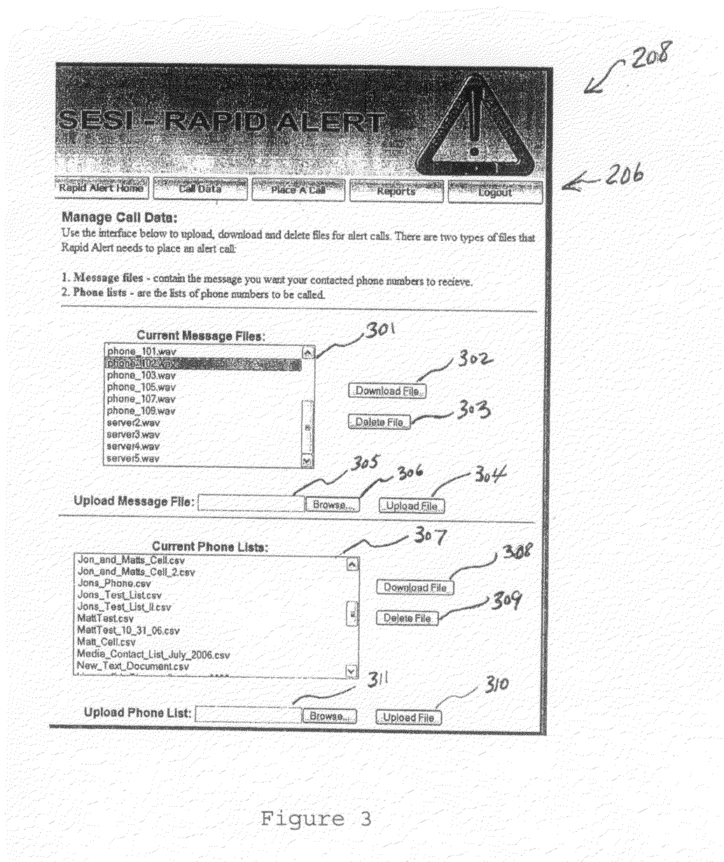

Referring next to FIG. 3, the edit (or manage) call data screen 208 is shown. The edit call data screen 208 operates generally as described above with respect to FIG. 2. User choices are displayed as a row of buttons 206 corresponding to user choice 206 in FIG. 2, that include call data option 208, place a call option 210 and reports option 212. Buttons 210 allow the user to navigate between the various options screens, and other screens, e.g., home page and logout. The message file window 301 allows the user to view and scroll through a list of stored alert call messages and select any one alert call message file to be broadcast. The Download File button 302 and the Delete File button 303 allow the user to download or delete the selected file 301. An Upload File button 304 allows the user to upload a file from the user's local computer to the list of stored messages 301, via an input window 305. The input window allows the user to identify by typing the complete file directory string and file name, or to automatically select an existing file via the Browse button 306, a file in a directory tree.

In the lower half of the edit call data screen 208, a current phone lists window 307 allows the user to view a list of telephone list files 307, download a selected file by selecting button 308, delete a selected file by selecting button 309, upload a telephone list file by selecting button 310, when a telephone list file is identified in the Upload Phone List: window 311.

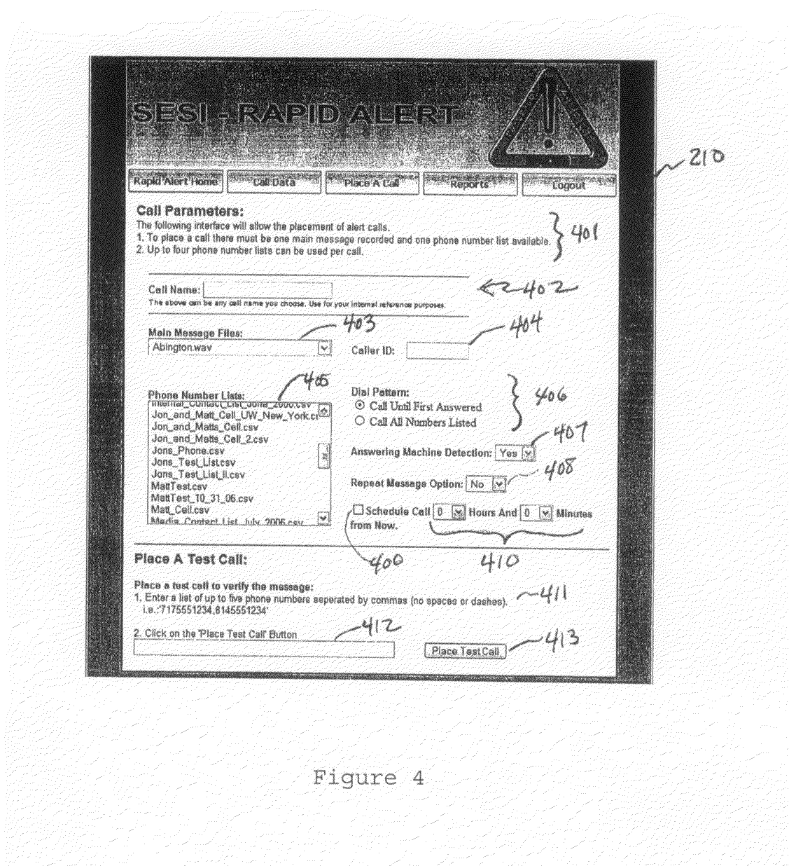

Referring next to FIG. 4, the Place A Call screen 210 is shown, corresponding to the description of place call option 210 in FIG. 2. User instructions 401 are placed at the top of the screen 210, followed by a Call Name entry field 402 that allows the user to specify a name by which to reference an alert call. A selection window 403 allows the user to select a message file from a drop down menu. A text box allows the user to assign a telephone number that is an authorized caller identification (ID) source. The user selects one or more telephone lists in the Phone Number Lists shown in window 405. The user clicks on one of two Dial Pattern options provided at 406, i.e., Call until First Answered or Call All Numbers Listed. The user optionally selects to use answering machine detection means at drop down menu 407, and is provided with a selection window 408 to specify whether to repeat the message. The user then selects whether to schedule the alert call in check box 409, and specifies the timing of broadcasting the alert call in windows 410.

In the lower portion of the Place a Call screen 210, the user is instructed 411 on placing a test call, allowed to insert a list of telephone numbers up to a limit, which in the example in FIG. 4 is up to five telephone numbers, in window 412, and when ready, the user selects button 413 to place the test calls.

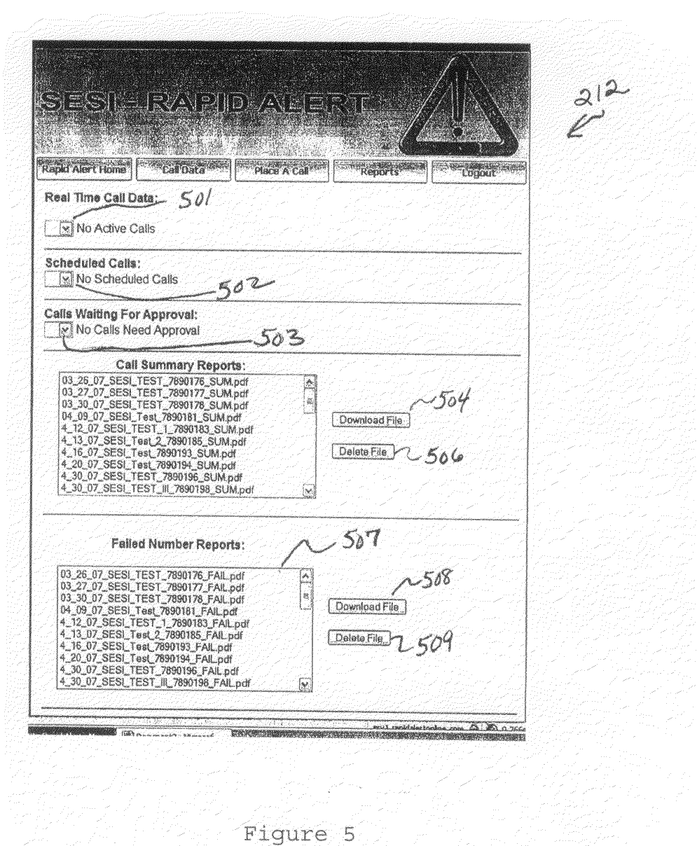

Referring next to FIG. 5, the Reports screen 212 is shown. The Reports screen has a window 501 to select which active calls, if any, that the user may select by number to view the real time call data associated with the selected call. The Scheduled Calls window 502 allows the user to view the calls that are currently scheduled to be broadcast. The Calls Waiting for Approval window 503 allows the user to view the number of alert calls that are waiting for user approval before the calls can be sent. A list of call summary report files is displayed to the user in window 504, and the user may select a report in window 504 and download the selected report file by clicking on the Download File button 505, or the user may also delete a selected file by clicking on the Delete button 506. A list of Failed Number reports is viewable by the user in window 507, and the report files may be downloaded by the user by clicking on the Download File button 508, or deleted by clicking on the Delete button 509.

The call servers in the call server array 3 place calls via a predetermined and agreed upon protocol (i.e. SIP) that the VoIP provider is configured to accept. VoIP does not require the users or the notification system operator to maintain expensive proprietary hardware to perform call routing functions, as these functions are executed in software. In one embodiment, custom dial plans are implemented in the Asterisk® PBX software, by Digium, Inc. Traditional automatic dialers need one copper phone line for each simultaneously placed call. Each copper phone line requires a separate telephone number to be associated with it, and the telephone line must have a direct connection to a PBE. Placing any large amount of simultaneous calls in the traditional manner thus becomes extremely costly. Additionally, the typical long distance charges that apply to traditional telephone service, they tend not to apply, or the rates are steeply discounted, when using VoIP. While the rates are of course is dependant on the VoIP provider, many VoIP providers charge a flat rate for any call, regardless of the place of origination of the call in the continental United States, largely due to the fact that VoIP transmits packets over the Internet, and thus does not require long distance telephone switches for placement of telephone calls that would normally be toll calls by the traditional telephone providers.

Referring next to FIGS. 4-7, there are provided screen images 32, 34, 36 and 38, that are generated in one embodiment of the data portal 10. Optionally, the system 100 may utilize a client Geographic Information System (GIS) database (not shown). The data portal 10 interfaces via a public or private network that is connected to or accessible with a customer database, e.g., a GIS or customer billing database. The data portal 10 extracts telephone numbers for customers, e.g., in response to a query setting forth the criteria for customers who are to be notified. FIG. 4 shows the query tab 38, with the associated fields menu window 40, that provides a selection element and drop down menu identifying various fields for searching. There is a values list 42 that includes a list of associated values for the field 40 that is selected. In the exemplary query tab 38 of FIG. 4, there are shown a partial listing of values or arguments 42 that are used to specify search criteria. A message recording selection tab 44 is shown in screen image 34. When tab 44 is selected, e.g., by a mouse click or other navigation

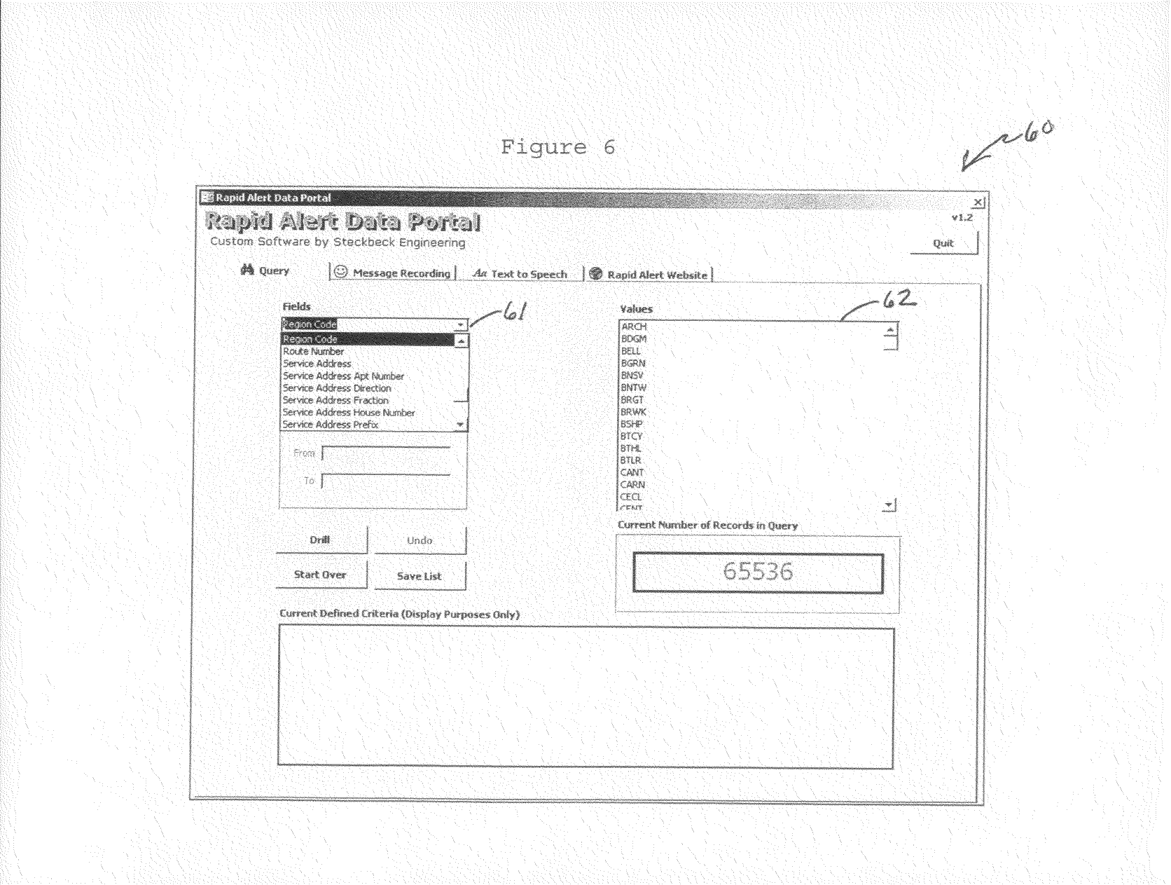

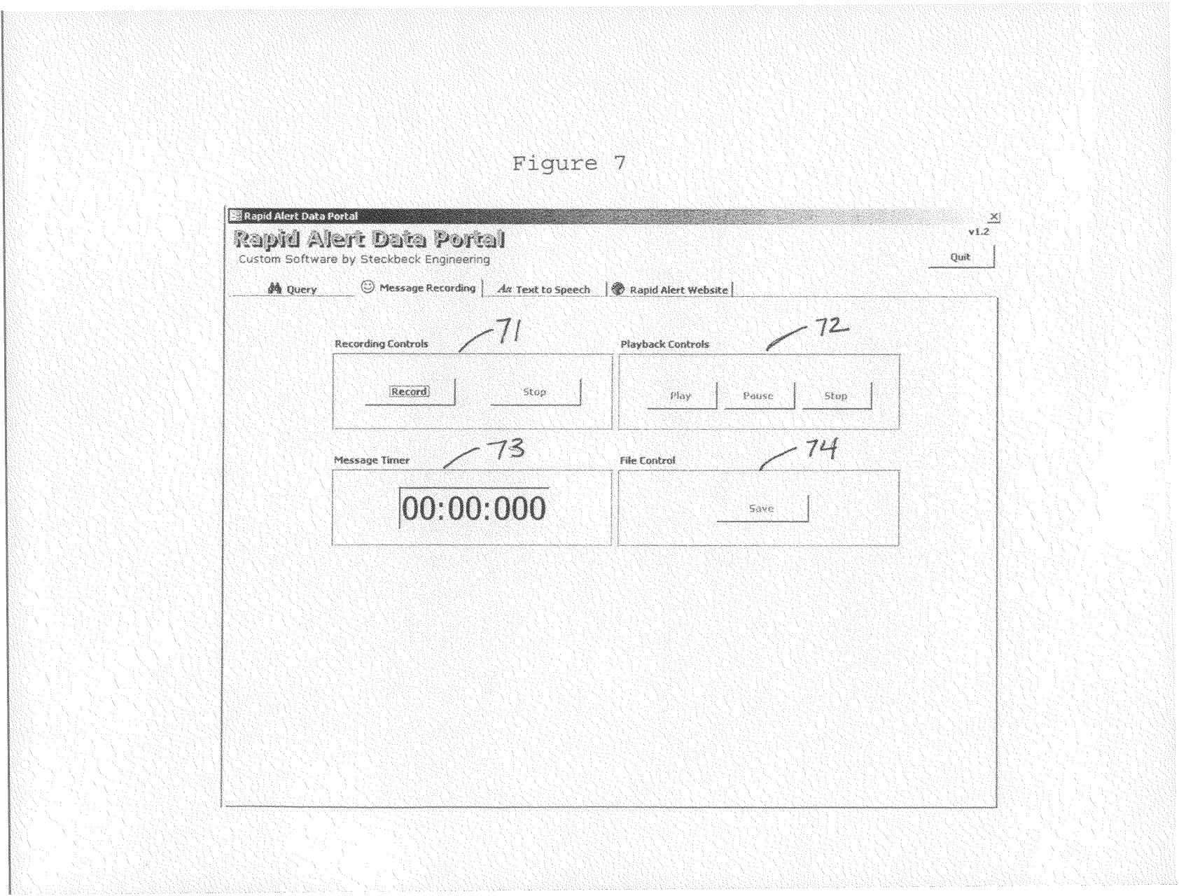

FIGS. 6-9 display exemplary data portal screens. The data portal screens may vary in the arrangement according to the particular application, however, the functionality remains generally the same. Referring to FIG. 6, the data portal screen 60 enables querying a remote customer database and generating phone lists. A field selection window 61 enables the user to designate a field, and a window 62 displays a list of corresponding values for the selected field. FIG. 7 is a data portal screen 60 that facilitates recording a message locally on the customer computer (not shown), via a microphone, with the recorded message to be uploaded to the system via the website. Recording controls 71, playback controls 72, message timer 73 and file control 74 are provided.

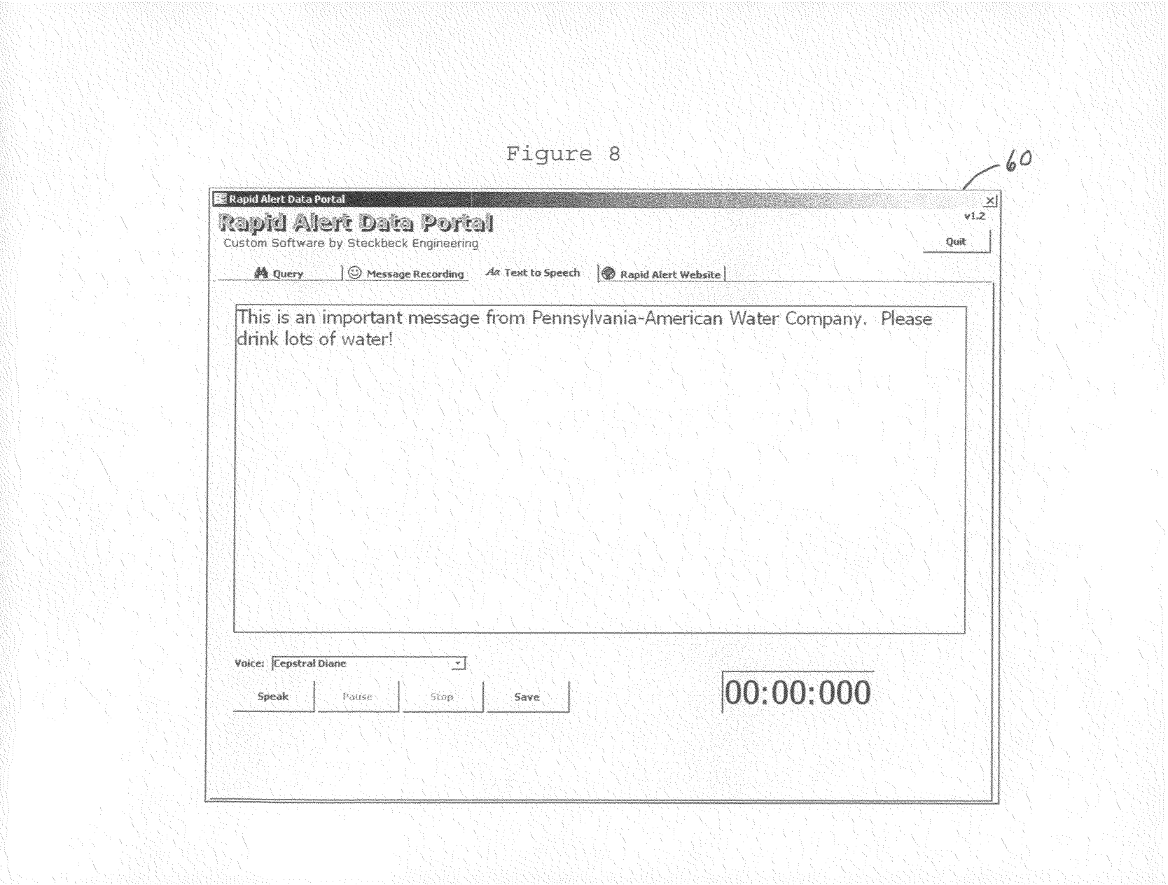

Referring to FIG. 8, the user may generating a local, synthesized message using TTS to be uploaded to the system via the website. Finally, FIG. 9 illustrates the login screen 90 of the website 60 displayed inside the portal software. A username field 91 and a password field 92 are used for secure login.

While the exemplary embodiments illustrated in the figures and described herein are presently preferred, it should be understood that these embodiments are offered by way of example only. Accordingly, the present application is not limited to a particular embodiment, but extends to various modifications that nevertheless fall within the scope of the appended claims. The order or sequence of any processes or method steps may be varied or re-sequenced according to alternative embodiments.

The present application contemplates methods, systems and program products on any machine-readable media for accomplishing its operations. The embodiments of the present application may be implemented using an existing computer processors, or by a special purpose computer processor for an appropriate system, incorporated for this or another purpose or by a hardwired system.

It is important to note that the construction and arrangement of the automated telephone notification system using VoIP, as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, display arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied, and the nature or number of discrete elements or positions may be altered or varied. Accordingly, all such modifications are intended to be included within the scope of the present application. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and omissions may be made in the design, operating conditions and arrangement of the exemplary embodiments without departing from the scope of the present application.

As noted above, embodiments within the scope of the present application include program products comprising machine-readable media for carrying or having machine-executable instructions or data structures stored thereon. Such machine-readable media can be any available media which can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions comprise, for example, instructions and data which cause a general purpose computer, special purpose computer, or special purpose processing machines to perform a certain function or group of functions.

It should also be noted that although the figures herein may show a specific order of method steps, it is understood that the order of these steps may differ from what is depicted. Also two or more steps may be performed concurrently or with partial concurrence. Such variation will depend on the software and hardware systems chosen and on designer choice. It is understood that all such variations are within the scope of the application. Likewise, software implementations could be accomplished with standard programming techniques with rule based logic and other logic to accomplish the various connection steps, processing steps, comparison steps and decision steps.

What is claimed is:

1. A system for automatic telephone notification using Voice over Internet Protocol (VoIP), comprising:
a data portal module associated with a database having an interface module for connecting the system to the Internet;
the data portal module configured to access the database to query the database for customer related information and to identify a data subset of the database; generate at least one customer list including a plurality of customer records; create and save voice notification messages from textual sources; record notification messages for distribution via telephone; and provide an interface between the system and a website;
a master server computer configured to receive recorded messages from a remote location; receive a post-call data report related to a predefined alert call message; and communicate instructions for placing alert message telephone calls to the at least one customer list;
a call server array including at least one call server in data communication with the master server computer and with a VoIP network, the call server array configured to: receive the instructions for placing alert message telephone calls from the master server; place alert message telephone calls according to the instructions communicated from the master server; receive alert call data from the VoIP network; and transmit the received alert call data to the master server;
wherein the alert call message is broadcast through the VoIP network to a plurality of customers identified in the at least one list.

2. The system of claim 1, wherein each customer record includes a customer identifier field, and a plurality of telephone number fields, wherein all of the fields in each customer record are comma separated.

3. The system of claim 2, wherein the user may select to save the at least one customer list in a local data file stored on the user's local computer or a local network with which the user's computer is in data communication.

4. The system of claim 3, wherein the recorded alert call messages are retrievably stored and played back to the customers identified in a customer call list in response to a stored request by a client.

5. The system of claim 1, wherein at least ten messages can be recorded and stored in a directory on the master server computer

6. The system of claim 5, wherein each stored alert call message is assigned a numerical identifier from zero through nine, such that the stored alert call message can be retrieved later by reference to the numerical identifier

7. The system of claim 1, wherein the notification messages are produced in a .wav format and uploaded from a client computer to the master server computer via a text-to-voice message uplink to the master server computer via the associated website.

8. The system of claim 1, wherein the notification message is created by the Portal Software in text to voice message module.

9. The system of claim 2, wherein the comma-separated files may be uploaded to the master server via a data link containing formatted telephone data.

10. The system of claim 9, wherein each comma-separated file includes at least five fields, one field having a unique identifier among the record set, and at least four fields having a ten digit telephone numbers, which telephone numbers are preferably unformatted.

11. The system of claim 1, wherein the master server computer includes an Interactive Voice Response (IVR) module for receiving the recorded messages.

12. A method of automatically placing emergency notification calls over a VoIP telephone network, comprising:
initiating a web session at a remote customer location;
providing a plurality of options, including an edit call option, a place call option, and a report option;
selecting one option from the plurality of selection options;
in response to selecting the edit call option, performing one of:
uploading at least one message file from a local resource; downloading message files from a master server to the local resource; and deleting message files from the master server; uploading at least one formatted telephone list file to the master server from the local resource; downloading formatted telephone list files from the master server to the local resource; and deleting formatted telephone list files from the master server;
in response to selecting the place call option:
configuring a plurality of parameters for mass call distribution of a preselected message file selected from the at least one message file; initiating a call; and testing at least one telephone number using the preselected message file, up to a predetermined maximum number of telephone numbers;
in response to selecting the reports option, performing one of:
viewing a data set including results of calls being placed in real time; cancelling a telephone message call that is currently being placed; reviewing a schedule for placing recorded message; cancelling one or more of the scheduled recorded message; downloading telephone message call summary reports; downloading failed number reports; and downloading detail historical data records of calls

13. The method set forth in claim 12, further comprising the step of, after the initiating step:
displaying to the user a secure logon screen for accepting a username and password; and
providing access to the plurality of options screen in response to the entering an authorized username and password.

14. The method set forth in claim 12, wherein the step of configuring a plurality of parameters further comprises:
assigning a unique identifier name to a notification call for identification and automatic retrieval of the call parameters from a hard drive location; selecting a message file including an audio message to be broadcast to a preselected one of the formatted telephone list files; assigning a predetermined telephone number as an authorized caller ID source for generating a request; selecting a predetermined number of telephone lists; selecting a call sequence; selecting the a predetermined time for broadcasting the message; and broadcast calling the message to a plurality of message recipients included in the selected telephone lists at the predetermined time.

15. The method set forth in claim 12, wherein a message file may be one of the messages files uploaded to the master server using the edit call option.

16. The method set forth in claim 12, wherein a message file includes an audio message recorded directly to the master server.

17. The method set forth in claim 12, wherein the authorized caller ID source indicates the name of the originator, and displays the predetermined telephone number to which a recipient of a message may reply.

18. The method set forth in claim 12, further including the step of:
calling each of a plurality of customer telephone numbers that are associated with each customer account.

19. The method set forth in claim 12, further including the step of:
calling a plurality of telephone numbers that are associated with the customer account in a predetermined order until a live person answers a call, and discontinue calling at that point.

20. The method set forth in claim 12, further comprising the step of using an answering machine detection feature, and allowing a call recipient to replay the message.

21. The method set forth in claim 14 wherein the predetermined time for broadcasting the message includes a range of times between immediately and a predetermined maximum advance time.

22. The method as set forth in claim 14, further including the step of, in response to initiating the call, providing real time data corresponding to the call, and populating a report screen within approximately ten minutes after completion of the call.
